(19) United States
(12) Patent Application Publication
(10) Pub. No.: US 2012/0192603 A1
(43) Pub. Date: Aug. 2, 2012

(54) HIGH SECURITY LOCK CORE STRUCTURE

(76) Inventor: Tien Kao Liu, Pingtung County (TW)

(21) Appl. No.: 13/019,389

(22) Filed: Feb. 2, 2011

(51) Int. Cl. E05B 15/00

(52) U.S. Cl. 70/431

(57) ABSTRACT

A high security lock core structure includes a case, a core, multiple side bead units and multiple bead units. The case includes side holes for receiving the side bead units. The core includes bottom holes which communicate with the top holes. The bead units are located in the top holes and the bottom holes. Each side bead unit includes a side bead and a first resilient member. Each bead unit includes a bottom bead, a top bead, a second resilient member and a cover. The top bead of one of the bead units is replaced by a cone-shaped locking bead which has a cone-shaped base and located at the interfaces of the top and bottom holes to make the core be locked. When the core is in unlocked status by malicious ways, the bottom holes are moved to the side holes to lock the core again.

### FIELD OF THE INVENTION

The present invention relates to a lock core structure, and more particularly, to a high security lock core structure which is secured when being maliciously striking and picking. The lock core structure further includes side bead unit to prevent the lock from unlocked.

### BACKGROUND OF THE INVENTION

A conventional lock core structure is shown in FIG. 1 and generally includes a case 10 with a core 20 located therein, wherein multiple top bead paths 101 and bottom bead paths 201 are in communication between the case 10 and the core 20. Each top bead path 101 and bottom bead path 201 are provided in sequence with bottom beads 30, top beads 40, resilient members 50 and a cover 60 from the bottom to the top therein. The top beads 40 are biased by the resilient members 50 and toward into the bottom bead paths 201 such that the core cannot be rotated. As shown in FIG. 2 when a correct key 70 is inserted into the key hole of the core 20, the notches of the key 70 move the bottom beads 30 and the top beads 40, and the resilient members 50 are compressed. The top of each bottom bead 30 is located in alignment with the outer surface of the core 20, so that the core 20 can be rotated by rotating the key 70 to unlock the lock.

However, unauthorized persons may maliciously unlock the lock by inserting an universal key 70′ or an L-shaped member (not shown) into the key hole of the core 20. As shown in FIG. 3, the universal key 70′ includes multiple notches so that the bottom beads 30 are engaged with the notches and the core is rotated to make the bottom bead paths 201 of the core 20 slightly offset from the top bead paths 101 of the case 10 as shown in FIG. 4. The top beads 40 are clamped between the top bead paths 101 and bottom bead paths 201, and are positioned. A force is then applied to the universal key 70′ as shown in FIG. 5, the inclined surfaces of the notches of the universal key 70′ push the bottom beads 30 which are suddenly moved to impact the top beads 40 and compress the resilient members 50. When the resilient members 50 bounce back, because the bottom bead paths 201 of the core 20 are slightly offset from the top bead paths 101 of the case 10, the bottom beads 30 then drop back to the bottom bead paths 201 and the top beads 40 cannot drop into the bottom bead paths 201 and are located in the top bead paths 101 as shown in FIGS. 6 and 7. By repeatedly hit the universal key 70′, the core can be successfully rotated and the lock is unlocked. It is obvious that the conventional lock core cannot bear impact from outside.

The present invention intends to provide a lock core structure which improves the shortcomings of the conventional lock core and is secured under maliciously striking and picking.

### SUMMARY OF THE INVENTION

The present invention relates to a lock core structure and comprises a case, a core, multiple side bead units and multiple bead units, wherein the case includes a hollow portion and a bead receiving portion. The core is located in the hollow portion. The hollow portion has multiple side holes defined therethrough which are located on two sides of the bead receiving portion. The side bead units are located in the side holes. The side bead units have multiple top holes defined in a top thereof and the core has bottom holes which are located in communication with the top holes. Each of the bottom holes includes an enlarged shoulder facing radially outward. The bead units are located in the top holes and the bottom holes. Each side bead unit has a side bead and a first resilient member and each bead unit has a bottom locking bead, a top locking bead, a second resilient member and a cover. The top locking bead of one of the bead units is replaced by a cone-shaped locking bead which is rested on the shoulder of the bottom hole so as to define a gap between the cone-shaped locking bead and the bottom locking bead.

The bottom locking bead includes a hollow and cylindrical first bottom bead and a second bottom bead which is inserted into the first bottom bead. The top locking bead includes a hollow and cylindrical second top bead and a first top bead which is inserted into the second top bead. The second resilient member includes an inner resilient member and an outer resilient member. The inner resilient member biases the first top bead and the outer resilient member biases the second top bead. The cone-shaped locking bead includes a hollow and cylindrical cone-shaped top bead and a first top bead which is inserted into the cone-shaped top bead. The cone-shaped top bead includes an outward cone-shaped base extending from a mediate portion thereof.

The components of the bead unit having no cone-shaped locking bead are replaced by a bottom magnetic bead, a third top bead, a third resilient member and a cover. The bottom magnetic bead includes a hollow and cylindrical first bottom bead and a second bottom bead which is inserted into the first bottom bead. An inner resilient member is located in the first bottom bead and biases the second bottom bead.

The hollow portion has a filling hole which is located diametrically corresponding to the side hole, the side bead unit are inserted into the filling hole which is sealed by an end cap.

When the core structure is maliciously picked or hit, by the core located offset and the diameter of the base of the cone-shaped locking bead is smaller than the two respective diameters of the top and bottom holes to secure the core, so that the lock is unlocked. When the core is destructed, the side bead unit forms another locked status to improve the anti-theft function of the lock.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a conventional lock core;

FIG. 2 shows that the correct key is inserted into the conventional lock core;

FIG. 3 shows that the universal key is inserted into the conventional lock core;

FIG. 4 is a cross sectional view, taken along line A-A of FIG. 3;

FIG. 5 shows that the universal key is applied by a force and the top and bottom beads of the conventional lock core are moved;

FIG. 6 shows that the universal key is applied by a force and the conventional lock core is unlocked;

FIG. 7 is a cross sectional view, taken along line B-B of FIG. 6;

FIG. 8 is an exploded view to show the lock core structure of the present invention;

FIG. 9 is an end cross sectional view to show the side bead unit of the present invention;

FIG. 10 is another exploded view to show the lock core structure of the present invention;

FIG. 11 is a perspective view to show the lock core of the present invention;

FIG. 12 shows that the lock core of the present invention is in locked status;

FIG. 13 shows that the correct key unlocks the lock core of the present invention;

FIG. 14 shows that the universal key is inserted into the lock core of the present invention and a force is applied to the universal key;

FIG. 15 is a cross sectional view, taken along line C-C of FIG. 14;

FIG. 16 is a cross sectional view, taken along line D-D of FIG. 14;

FIG. 17 shows that the top and bottom beads drop respectively;

FIG. 18 shows the universal key is applied a force and tries to unlock the lock core of the present invention;

FIG. 19 shows the universal key is applied a force and the lock core of the present invention is rotatable;

FIG. 20 is a cross sectional view, taken along line E-E of FIG. 19;

FIG. 21 shows that the side bead unit locks the core of the present invention, and

FIG. 22 shows that the cone-shaped locking bead is installed to another top hole of the lock core structure of the present invention.

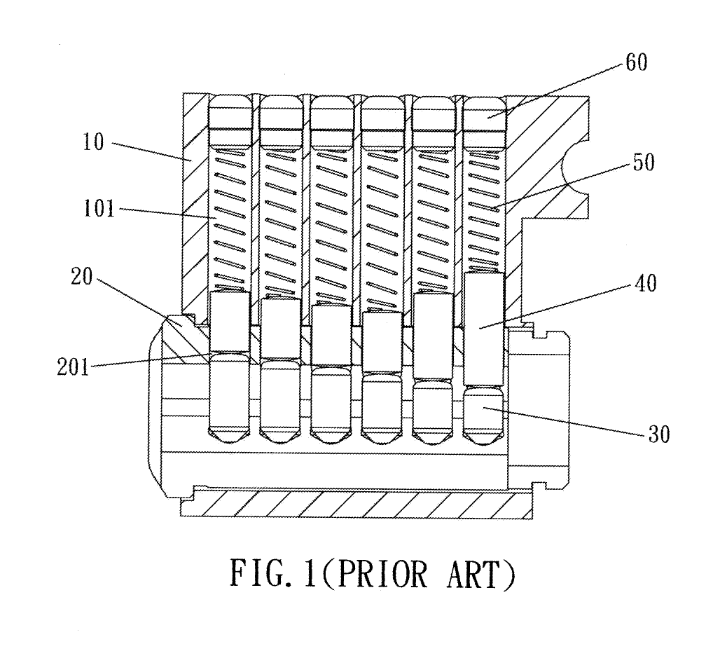

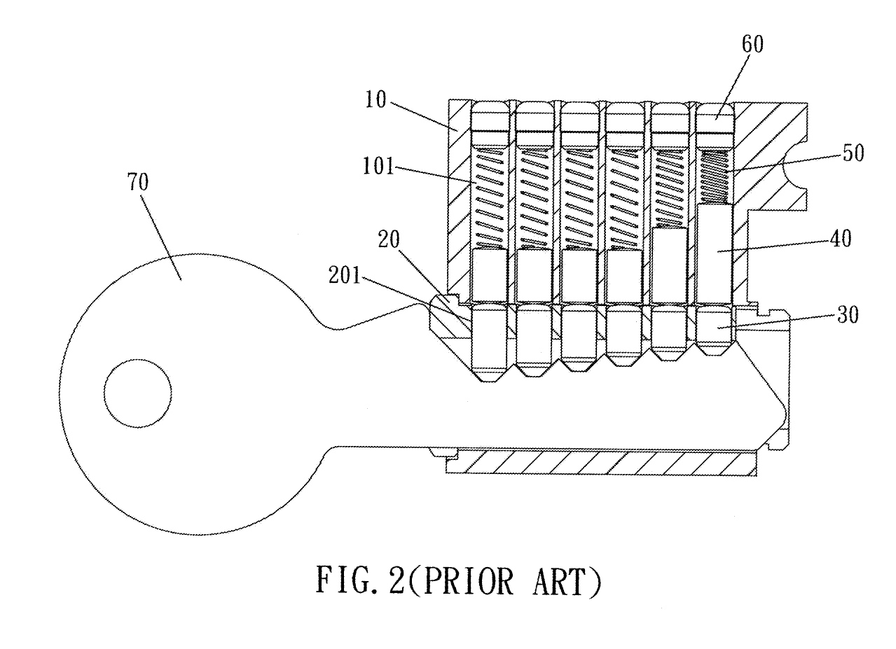

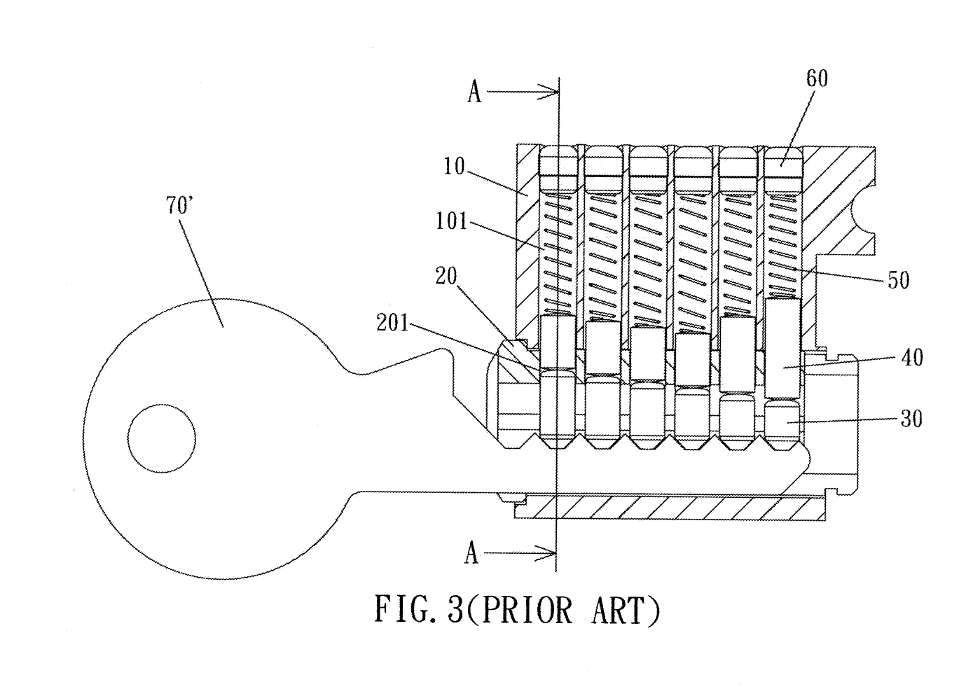

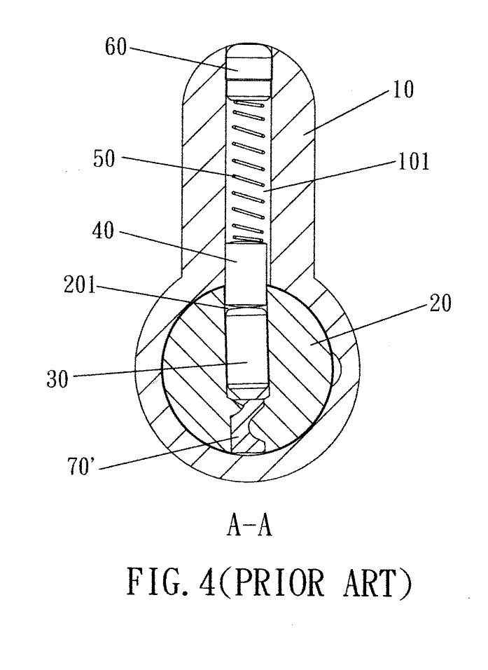

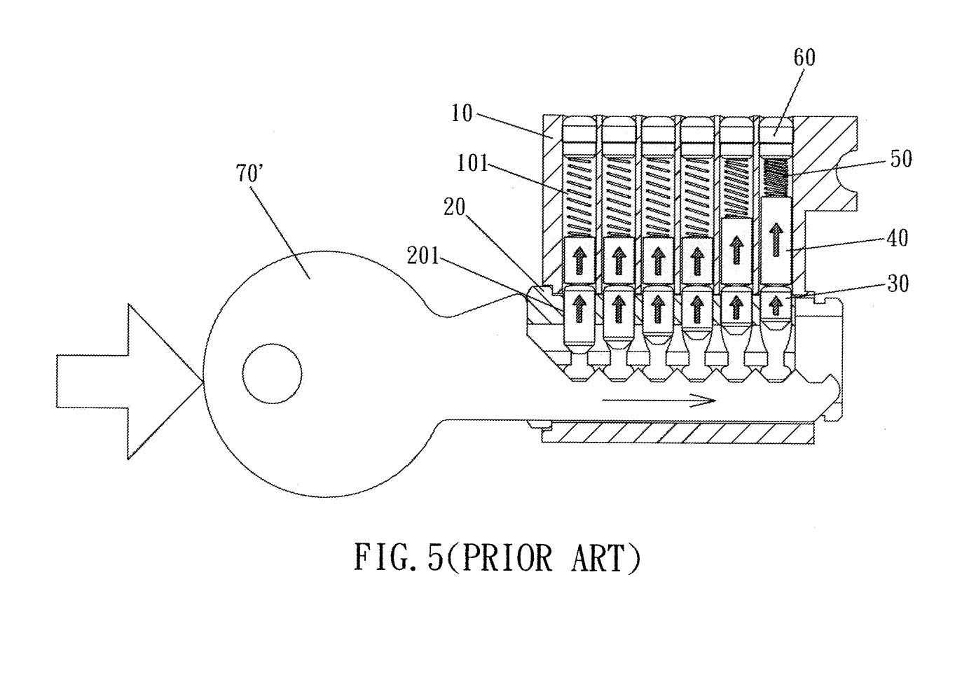

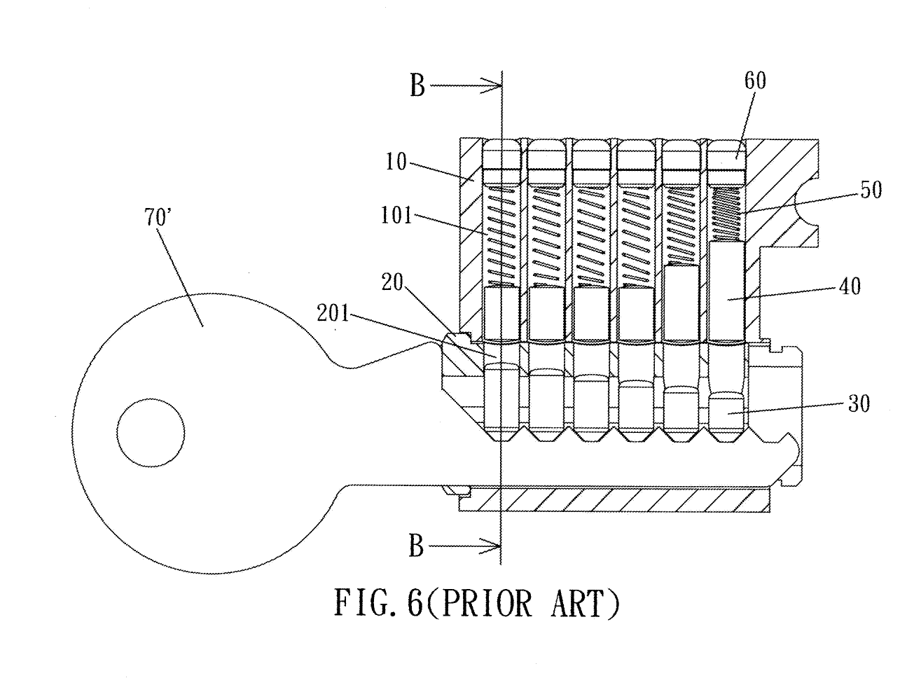

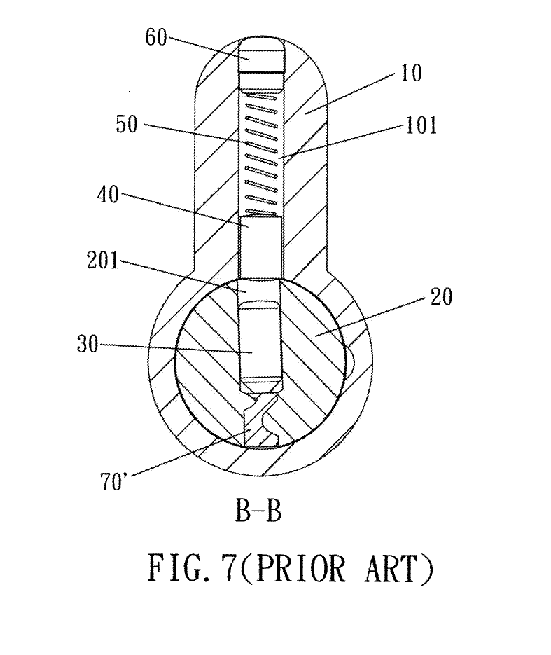

### DETAILED DESCRIPTION OF THE PREFERRED EMBODIMENT

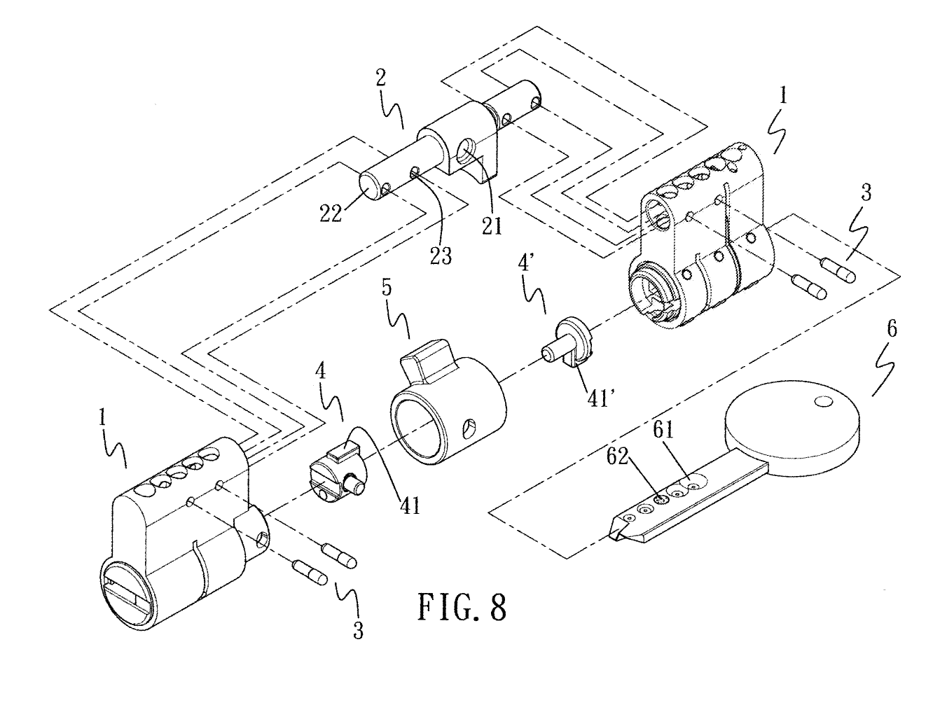

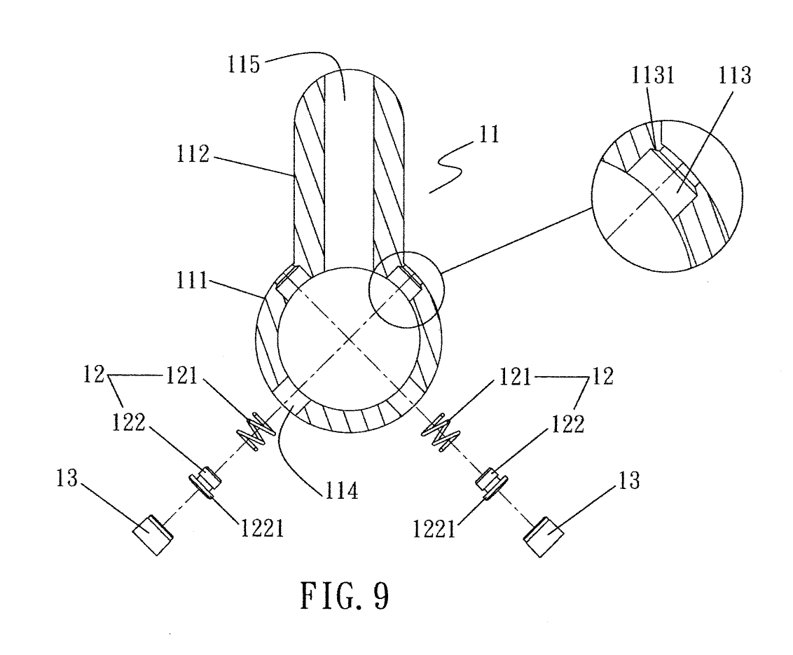

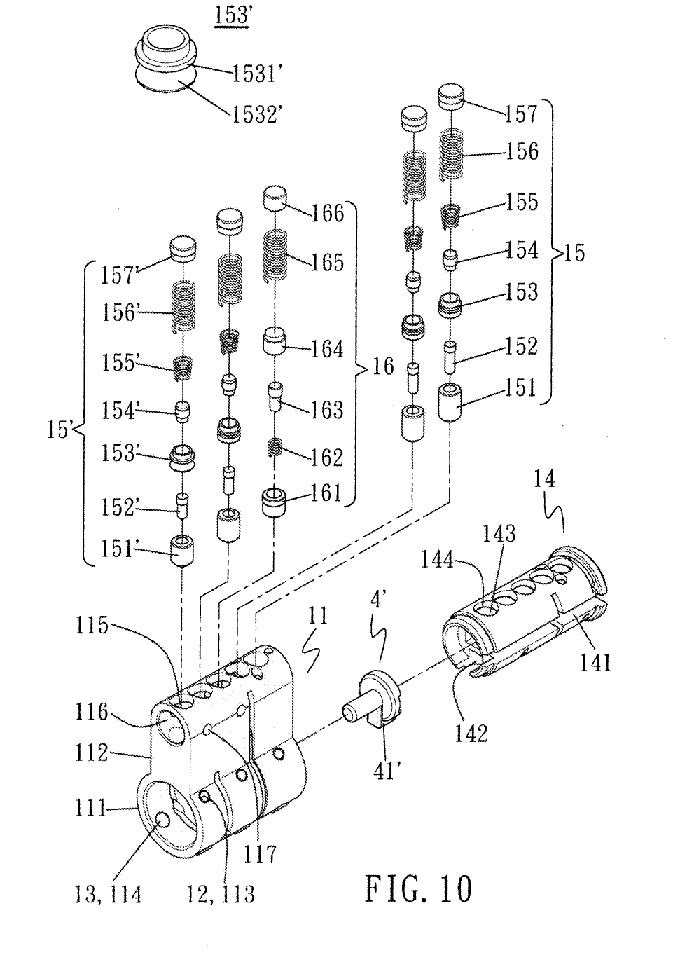

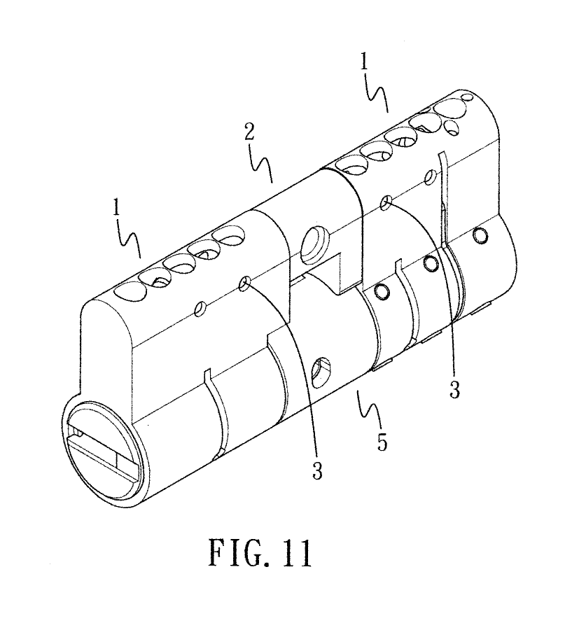

Referring to FIGS. 8 to 11, the lock of the present invention includes a pair of lock core structure 1, a connection rod 2, multiple pins 3, two transmission members 4, 4′, a cam 5, and a correct key 6.

The core structure 1 is symmetrically connected and each core structure 1 of the present invention comprises a case 11, multiple side bead units 12, multiple end caps 13, a core 14 and multiple bead units.

The case 11 includes a hollow portion 111 which is located axially of the case and includes a through way for receiving the core 14. A bead receiving portion 112 is integrally and radially formed to the hollow portion 111. The hollow portion 111 has multiple side holes 113 defined radially therethrough which are located on two sides of the bead receiving portion 112. In this embodiment, there are three pairs of the side holes 113. Each side hole 113 has a first shoulder 1131 in the inner periphery thereof and the first shoulder 1131 faces radially outward. The hollow portion 111 further has multiple filling holes 114 which are located diametrically corresponding to the side holes 113. The bead receiving portion 112 includes multiple top holes 115 defined in a top thereof, in this embodiment, there are five top holes 115 and the side holes 113 are located to some of the top holes 115. A passage 116 is defined through the bead receiving portion 112 and communicates with the top holes 115. The bead receiving portion 112 includes multiple pin holes 117 defined along the axis of the passage 116.

The side bead units 12 each includes a first resilient member 121 and a side bead 122 which is a cylindrical part and includes a flange 1221 on the end in contact with the core 14. The diameter of the flange 1221 is smaller than the inner diameter of the side holes 113, and larger than the outer diameter of the first shoulders 1131.

The end caps 13 are securely engaged with the filling holes 114 of the hollow portion 111.

The core 14 has an outer diameter which is matched with the through way of the hollow portion 111 so that the core 14 is received in the through way. The core 14 has a key hole 141 defined axially through a first end thereof and a notch 142 is defined in a second end of the core 14. The core 14 further has bottom holes 143 which are located in communication with the top holes 115 of the bead receiving portion 112, so that the key hole 141, the bottom holes 143 and the top holes 115 are in communication with each other. The inner diameter each of the bottom holes 143 is slightly smaller than the inner diameter of the top holes 115. Each of the bottom holes 143 includes an enlarged second shoulder 144 facing radially outward. The inner diameter of the portion located above the second shoulder 144 of the bottom hole 143 is the same as the inner diameter of the top holes 115.

The bead units are located in the top holes 115 and comprises multiple first bead units 15, multiple second bead units 15′ and a third bead unit 16, wherein the each of the first bead units 15 includes a first bottom bead 151, a second bottom bead 152, a second top bead 153, a first top bead 154, an inner resilient member 155, an outer resilient member 156 and a cover 157. The first bottom bead 151 is a hollow and cylindrical member and the second bottom bead 152 is inserted into the first bottom bead 151. The combination of the first bottom bead 151 and the second bottom bead 152 forms the bottom locking bead. The second top bead 153 is a hollow and cylindrical member and the first top bead 154 is inserted into the second top bead 153. The combination of the first top bead 154 and the second top bead 153 forms the top locking bead. The inner resilient member 155 biases the first top bead 154 and the outer resilient member 156 biases the second top bead 153, and thereby forming the second resilient member. All of the components of the bead units have an inner diameter which is smaller than the inner diameters of the top holes 115 and the bottom holes 143, so that the components are movable in the top holes 115 and the bottom holes 143. The second bead unit 15′ includes a first bottom bead 151′, a second bottom bead 152′, a cone-shaped top bead 153′, a first top bead 154′, an inner resilient member 155′, an outer resilient member 156′ and a cover 157′. The cone-shaped top bead 153′ is a hollow and cylindrical member and the first top bead 154′ is inserted into the cone-shaped top bead 153′. The combination of the cone-shaped top bead 153′ and the first top bead 154′ forms the cone-shaped locking bead. The difference of the second bead unit 15′ from the first bead unit 15 is that the top locking bead of the first bead unit 15 is replaced by a cone-shaped locking bead so as to form the second bead unit 15′. The cone-shaped top bead 153′ includes a lip 1531′ extending outward from a mediate portion thereof and an outward cone-shaped base 1532′ extending from the mediate portion thereof and toward the bottom hole 143. The diameter of the base of the cone-shaped base 1532′ is larger than the inner diameter of the bottom holes 143, while smaller than the inner diameter of the second shoulder 144 and the inner diameter of the top holes 115. Therefore, the cone-shaped base 1532′ can only move in the space above the second shoulder 144 of the bottom hole 143. The components of the third bead unit 16 is the bead unit that has no cone-shaped locking bead and the components are replaced by a first bottom bead 161, an inner resilient member 162, a second bottom bead 163, a third top bead 164, a third resilient member 165 and a cover 166. The first bottom bead 161 is a hollow and cylindrical member and the inner resilient member 162 and the second bottom bead 163 are inserted into the first bottom bead 161. The first bottom bead 161 and the second bottom bead 163 are connected in one direction so as to form the bottom magnetic bead. The third top bead 164 has a space in the top thereof for receiving the second bottom bead 163, so that the inner resilient member 162 can push the second bottom bead 163 into the space of the third top bead 164. Furthermore, each of the first bottom bead 151, the second bottom bead 152, the second top bead 153, the cone-shaped top bead 153′, the first top beads 154, 154′, the first bottom bead 161, the second bottom bead 163 and the third top bead 164 has its individual axial length according the design. The first bead unit 15, the second bead unit 15′ and the third bead unit 16 are connected to the top and bottom holes 115, 143 according to practical needs.

The connection rod 2 has a threaded hole 21 defined in the center thereof so as to fix the connection rod 2 to the door. The connection rod 2 includes two end portions 22 extend from two ends thereof so as to be securely engaged with the passages 116 of the case 11. Pin holes 23 are defined in the end portions 22 and located corresponding to the pin holes 117 of the bead receiving portion 112 of the first bead unit 15.

The pair of pins 3 are securely engaged with the pin holes 117, 23 of the bead receiving portion 112 and the connection rod 2.

The pair of transmission members 4, 4′ each have a protrusion 41, 41′ which is located corresponding to the notch 142 of the core 14.

The cam 5 includes two respective spaces on two sides thereof for accommodating the transmission members 4, 4′ so as to control the unlocking actions in two directions.

The key 6 includes multiple recesses 61 for correctly moving the beads of the bead units. A magnetic member 62 is located in one of the recesses 61 so as to attract the second bottom bead 163.

As shown in FIGS. 8 to 12, when assembling the lock, the core structure 1 is first completed and the steps for assembling the core structure 1 is to insert the first resilient members 121 of the side bead units 12 and the side beads 122 into the side holes 113 via the hollow portion 111. In detail, the first resilient members 121 and the side beads 122 are inserted into the side holes 113 via the filling holes 114, until the first resilient members 121 reach the first shoulders 1131 of the side holes 113. The core 14 is then inserted into the hollow portion 111 to urge the first resilient members 121 and the side beads 122 are restricted between the outside of the core 14 and the first shoulder 1131 of the hollow portion 111. The side beads 122 are biased by the first resilient members 121 so as to contact the outside of the core 14 to form the side bead units 12. The end caps 13 then seal the filling holes 114 of the hollow portion 111.

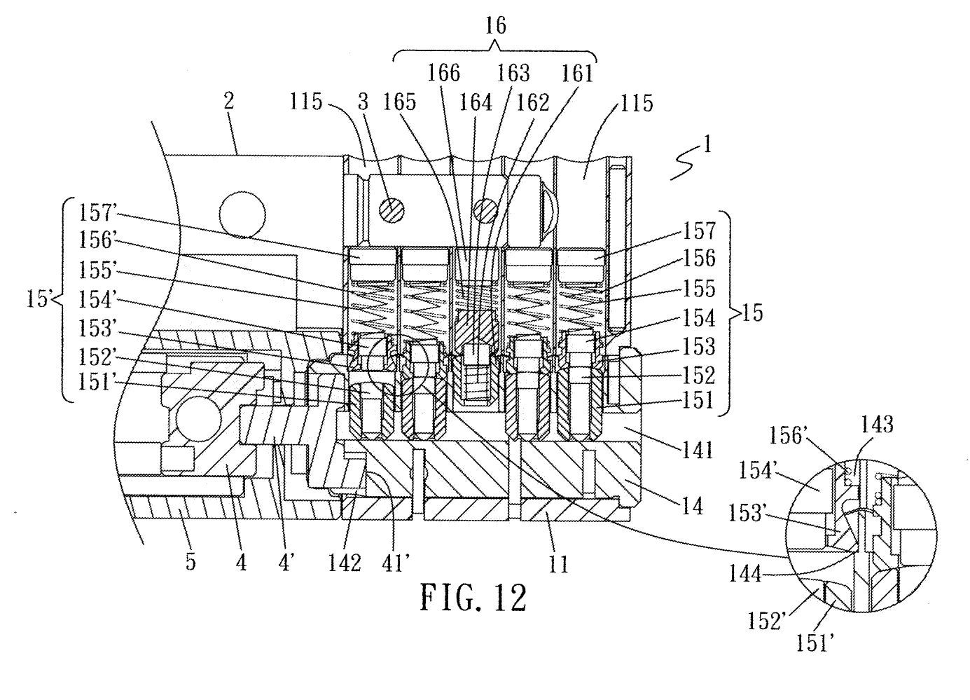

After the core 14 is installed in the hollow portion 111, the bottom holes 143 are arranged to be in alignment with the top holes 115 of the bead receiving portion 112, and the bottom bead, the top bead, the second resilient members and the covers 157 are filled in the bottom holes 143 and the top holes 115. One of the top beads is replaced by the cone-shaped locking bead to form the second bead unit 15′. In this embodiment, the second bead unit 15′ having the cone-shaped locking bead is located at the remote position from the key hole 141. The third bead unit 16 is then inserted into the bottom holes 143 and the top holes 115, from bottom to the top, the bottom magnetic bead, the third top bead 164, the third resilient member 165 and cover 166 are respectively installed in sequence. The way of the installation can be set according to requirement. The bead units are restricted in the bottom holes 143 and the top holes 115 when the covers 157, 166 are installed. The top locking bead (cone-shaped locking bead) is biased by the second resilient members and is pushed into the bottom holes 143 such that the bottom of the top locking bead contacts the top of the bottom locking bead. The second bead unit 15′ having the cone-shaped locking bead which has the cone-shaped base 1532′ is larger than the inner diameter of the bottom hole 143 and smaller than the inner diameter of the second shoulder 144, and the axial length of the bottom locking bead of the second bead unit 15′ is made to be shorter such that the bottom of the cone-shaped base 1532′ of the cone-shaped top bead 153′ is rested on the second shoulder 144. Therefore, a gap is defined between the cone-shaped locking bead and the bottom locking bead. By this arrangement, the bottom of the bottom locking bead extends to the key hole 141 of the core 14 to made the top locking bead (cone-shaped locking bead) be located at the inter surfaces of the protrudes out from the bottom holes 143 and the top holes 115 as shown in FIG. 12, the core 14 cannot be rotated. Furthermore, for the third bead unit 16 having the magnetic member, the first bottom bead 161 is engaged with the second shoulder 144 of the bottom hole 143 to define a gap between the first bottom bead 161 and the key hole 141 of the core 14. The inner resilient member 162 located between the first bottom bead 161 and the second bottom bead 163 pushes the second bottom bead 163 upward and located in the space at the bottom of the third top bead 164. Therefore, the second bottom bead 163 is located at the inter surfaces between the bottom holes 143 and the top holes 115 to further lock the core 14 from being rotated.

The two end portions 22 of the connection rod 2 are inserted into the passages 116 of the bead receiving portions 112. The pin holes 117 of the bead receiving portion 112 are in alignment with the pin holes 23 of the connection rod 2, and the pins 3 are inserted into the pin holes 117, 23 to connect the core structure 1 to the connection rod 2. The number of the pins 3 is matched with the number of the pin holes 117, 23. The two respective ends that have the notch 142 of the cores 14 are located to face to each other and the two protrusions 41, 41′ of the two transmission members 4, 4′ are engaged with the notches 142 of the two cores 14. The cam 5 is positioned between the two transmission members 4, 4′ so that the unlocking actions in two directions can be controlled.

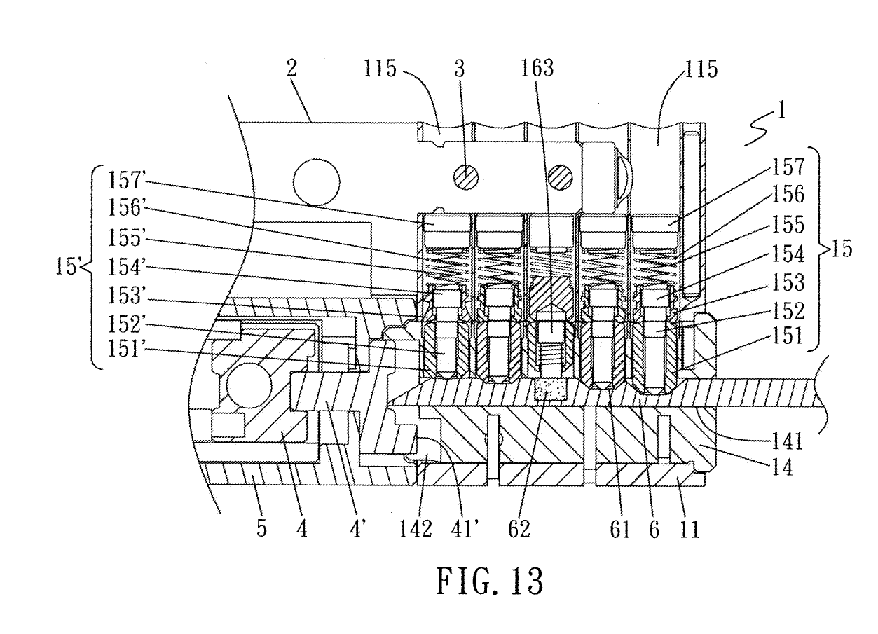

As shown in FIG. 13, when unlocking the lock with the use of the correct key 6, the depths of the recesses 61 are calculated to be matched with the core structure 1. When the key 6 is inserted into the key hole 141, the bottom locking beads are pushed upward by the recesses 61 and the height that the bottom locking beads raised pushes the top locking beads (cone-shaped locking bead) to be separated from the bottom holes 143 and enter into the top holes 115. The magnetic member 62 attracts the second bottom bead 163 which is pushed by the inner resilient member 162, and the second bottom bead 163 moves downward a distance which makes the second bottom bead 163 leave the space of the bottom of the third top bead 164 and enter into the bottom hole 143 of the case 11. Therefore, all of the bottom locking beads and the top of the bottom magnetic bead are in flush with the opening of the bottom holes 143. The bottom of the top locking bead, the cone-shaped locking bead and the third top bead 164 are in flush with the opening of the top holes 115. The core 14 is then able to be rotated by rotating the key 16 to shift the bottom locking beads and the bottom magnetic beads in the bottom holes 143.

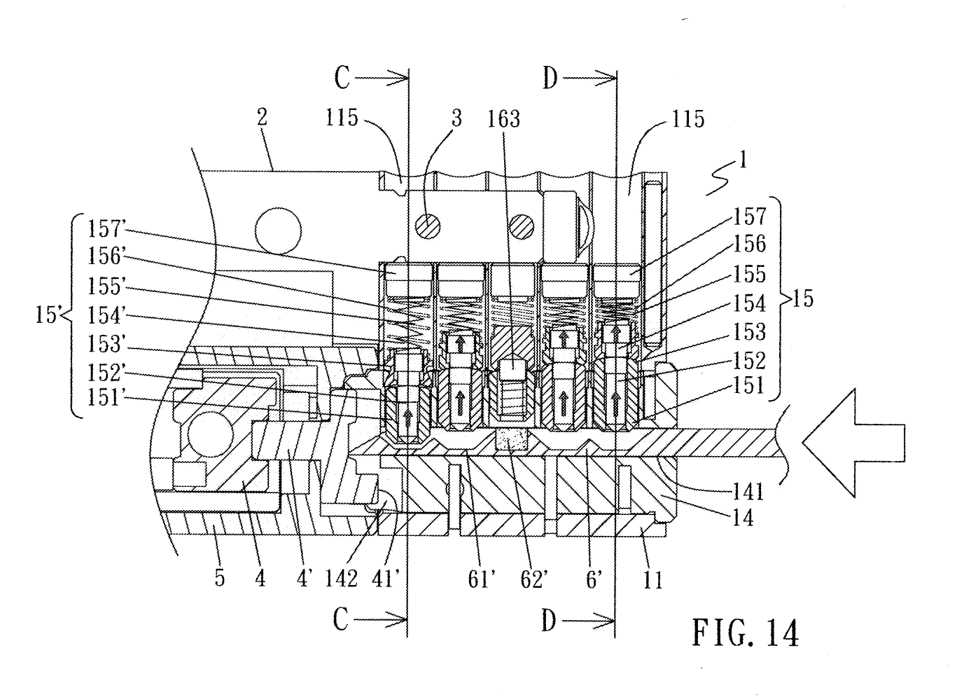

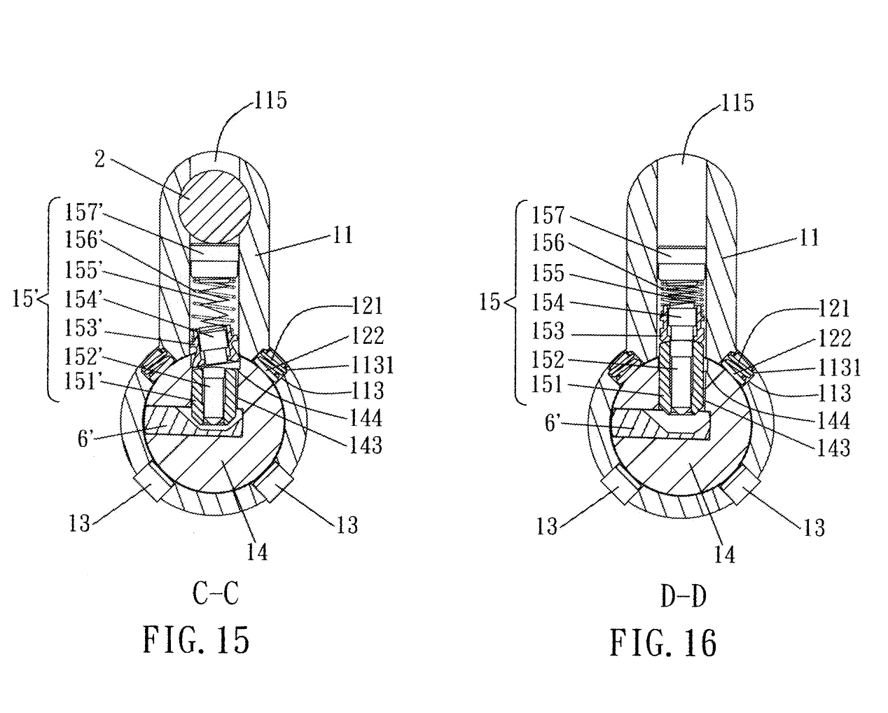

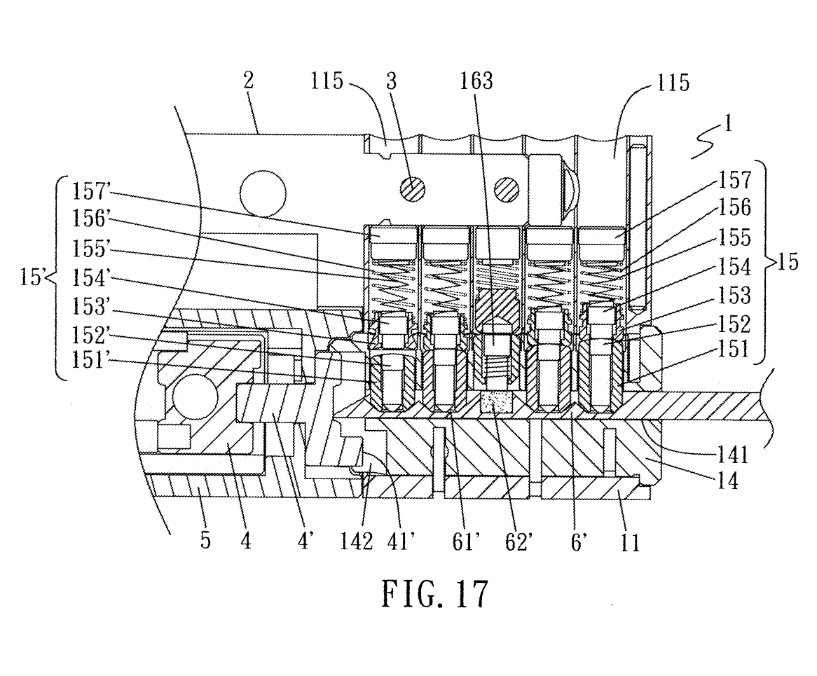

As shown in FIGS. 14 to 17, when unauthorized person uses an universal key 6′ or an L-shaped plate to unlock the lock by inserting the universal key 6′ into the key hole 141. The recesses 61′ of the universal key 6′ push the first bottom beads 151, 151′ upward, and the magnetic member 62′ attracts the second bottom beads 163 downward. Nevertheless, the cone-shaped base 1532′ is smaller than the inner diameter of the second shoulder 144 and the inner diameter of the top hole 115, so that when the core 14 is slightly rotated and offset from the case 11, a portion of the opening of each second shoulder 144 that is supposed to be in alignment with the top hole 115 is blocked by the inside of the case 11. Similarly, a portion of the opening of each top hole 115 is blocked by the outside of the core 14. Therefore, the distance between the two openings is shortened and smaller than the outer diameter of the cone-shaped base 1532′. Therefore, the cone-shaped base 1532′ cannot pass through the opening and has to be located in the bottom hole 143. If the core 14 and the case 11 are further offset from each other, the lip 1531′ of the cone-shaped top bead 153′ is pushed by the inside of the top hole 115 to tilt the cone-shaped locking bead because the cone-shaped base 1532′. A part of the cone-shaped base 1532′ is located in the bottom hole 143 and the other part of the cone-shaped base 1532′ is engaged between the conjunction between the second shoulder 144 and the inside of the case 11. The cone-shaped locking bead is further secured and cannot be moved as shown in FIG. 15. The rest of the top locking beads are still free of movement as shown in FIG. 16. Although the universal key 6′ successfully moves the bottom locking beads and compresses the second resilient members, but the tilted cone-shaped locking bead cannot move so that the lock can fight against maliciously picking and striking. If the top locking beads are pushed to the top holes 115, the core 14 is still stocked between the inter surfaces of the top holes 115 and bottom holes 143, and cannot be rotated. The only way is try to make the opening between the top holes 115 and the second shoulder 144 be bigger than the outer diameter of the cone-shaped base 1532′, such that the cone-shaped locking bead can be pushed upward. Nevertheless, to reach the purpose, the unauthorized person has to return the core 14 to allow the cone-shaped base 1532′ to pass through the top holes 115. If this is achieved, the top locking beads in the top holes 115 will drop to the inter surfaces between the top and bottom holes 115, 143, this is back to the initial locked status. As shown in FIG. 17, for the cone-shaped locking beads and the bottom locking beads, because the bottom of the cone-shaped base 1532′ of the cone-shaped locking bead is rested on the second shoulder 144 of the bottom hole 143, there is a gap between the cone-shaped top bead 153′ and the bottom locking bead, and the force that applies the universal key 6′ is absorbed by the first and second bottom beads 151, 152, the forces is not sufficient to move the first bottom bead 151′ to hit hard enough to the bottom of the cone-shaped locking bead. Therefore, the cone-shaped locking bead is stocked between the inter surfaces of the top and bottom holes 115, 143 to ensure the second bottom beads 152 and the first bottom beads 151 to drop into the bottom holes 143. The cone 14 cannot be rotated and the lock is not unlocked.

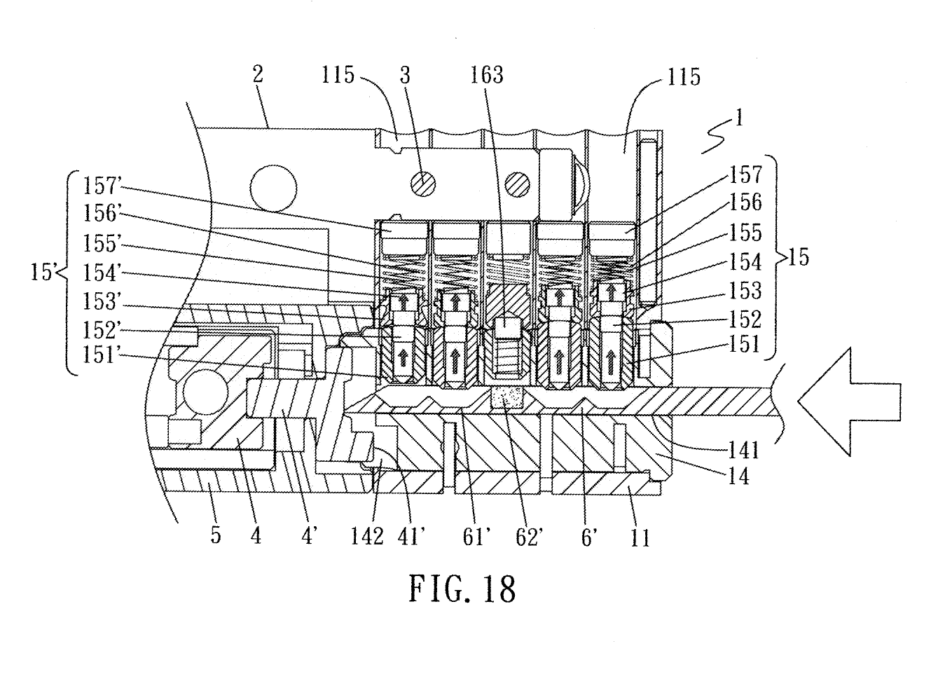

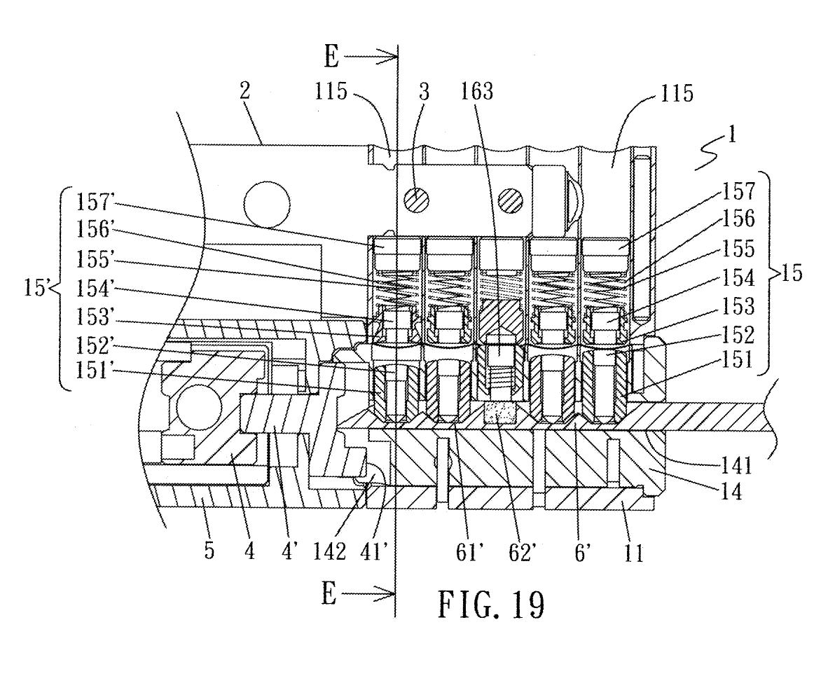

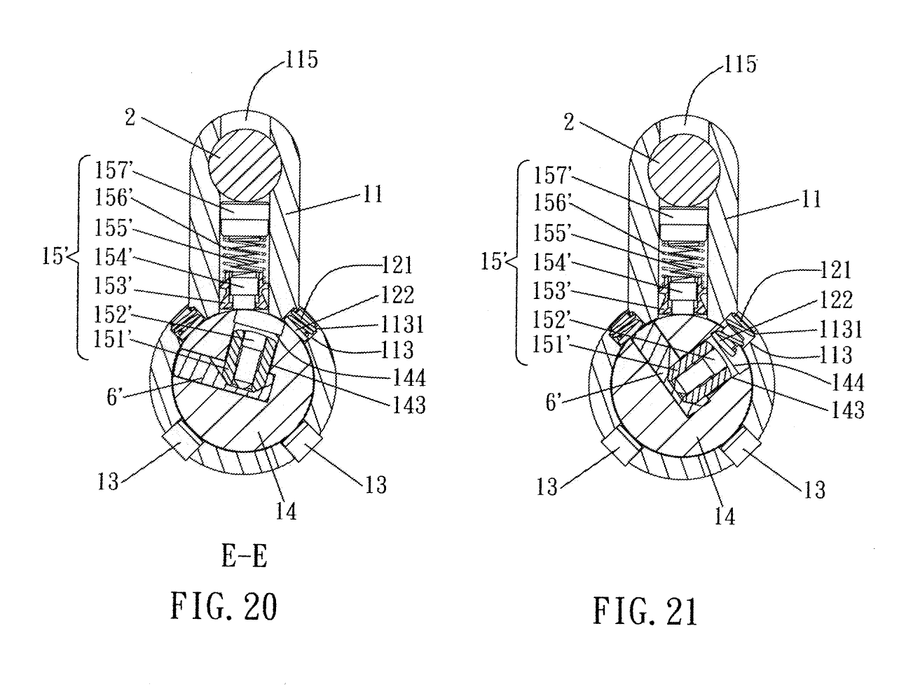

The lock core is highly safe and secured, and the unauthorized persons cannot unlock the lock core structure by picking or striking or by using a universal key. In order to reinforce the security feature, the lock core has side bead units 12. As shown in FIGS. 18-20, when the top locking beads and the cone-shaped locking beads are picked and moved to the top holes 115, the universal key 6′ is able to rotate the core 14 to move the bottom locking beads and bottom magnetic beads. Because the bottom locking beads are located in the recesses 61′ of the universal key 6′ and a gap is defined between the bottom locking beads and the opening of the bottom holes 143. The universal key 6′ is stocked in the key hole 141 and cannot be pulled out. When the universal key 6′ is rotated to move the bottom holes 143 to be in alignment with the side bead units 12, the outer diameter of the side beads 122 is smaller than the inner diameter of the bottom holes 143, so that the side beads 122 are pushed by the first resilient members 121 and drop into the bottom holes 143 to form the locked status as shown in FIG. 21. Besides, because the universal key 6′ is stocked in the key hole 141 by the bottom locking beads and cannot be moved, so that even if a force is applied to the universal key 6′, the recesses 61′ cannot push any bottom locking beads upward. The universal key 6′ is completely locked by the side bead units 12 and there is no space for inserting the L-shaped plate. The side beads 122 do not picked by the L-shaped plate so that the lock cannot be unlocked by any way of striking.

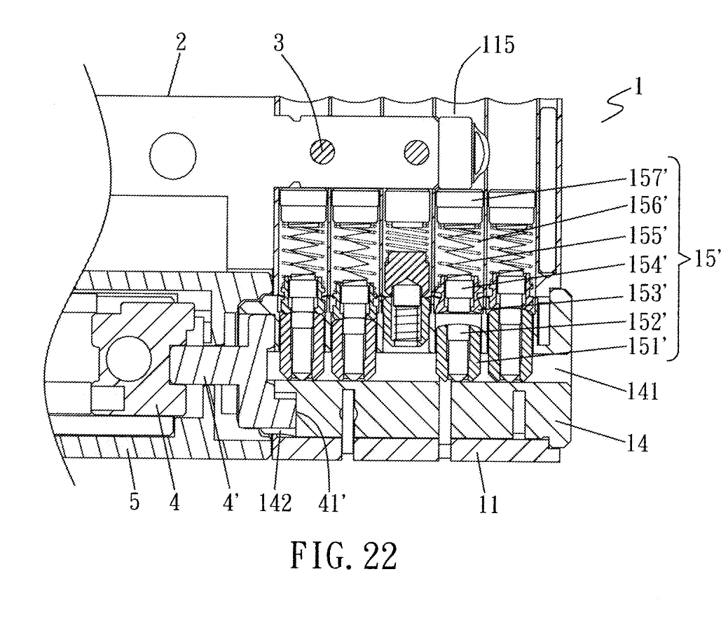

It is noted that the cone-shaped locking bead is installed in the top and bottom holes 115, 143 where are remote from the key hole 141, however, the position that the cone-shaped locking bead is installed can be varied and is not restricted by the embodiment disclosed. The cone-shaped locking bead can be installed to any of the top and bottom holes 115, 143 as shown in FIG. 22. The unauthorized persons are difficult to know where the cone-shaped locking bead is located, so that the lock core structure is even more secured.

While we have shown and described the embodiment in accordance with the present invention, it should be clear to those skilled in the art that further embodiments may be made without departing from the scope of the present invention.

What is claimed is:

1. A lock core structure (1) comprising:
a case (11), a core (14), multiple side bead units (12) and multiple bead units, the case (11) including a hollow portion (111) and a bead receiving portion (112), the core (14) located in the hollow portion (111), the hollow portion (111) having multiple side holes (113) defined therethrough which are located on two sides of the bead receiving portion (112), the side bead units (12) being located in the side holes (113), the bead receiving portion (112) having multiple top holes (115) defined in a top thereof and the core (14) having bottom holes (143) which are located in communication with the top holes (115), each of the bottom holes (143) including an enlarged shoulder (144) facing radially outward, the bead units located in the top holes (115) and the bottom holes (143), each side bead unit (12) having a side bead (122) and a first resilient member (121) and each bead unit having a bottom locking bead, a top locking bead, a second resilient member and a cover (157), the top locking bead of one of the bead units being replaced by a cone-shaped locking bead which is rested on the shoulder (144) of the bottom hole (143) so as to define a gap between the cone-shaped locking bead and the bottom bead.

2. The lock core structure as claimed in claim 1, wherein the bottom locking bead includes a hollow and cylindrical first bottom bead (151) and a second bottom bead (152) which is inserted into the first bottom bead (151), the top locking bead includes a hollow and cylindrical second top bead (153) and a firs top bead (154) which is inserted into the second top bead (153), the second resilient member includes an inner resilient member (155) and an outer resilient member (156), the inner resilient member (155) biases the first top bead (154) and the outer resilient member (156) biases the second top bead (153), the cone-shaped locking bead includes a hollow and cylindrical cone-shaped top bead (153′) and a first top bead (154′) which is inserted into the cone-shaped top bead (153′), the cone-shaped top bead (153′) includes an outward cone-shaped base (1532′) extending from a mediate portion thereof.

3. The lock core structure as claimed in claim 1, wherein components of the bead unit having no cone-shaped locking bead are replaced by a bottom magnetic bead, a third top bead (164), a third resilient member (165) and a cover (166), the bottom magnetic bead includes a hollow and cylindrical first bottom bead (161) and a second bottom bead (163) which is inserted into the first bottom bead (161), an inner resilient member (162) is located in the first bottom bead (161) and biases the second bottom bead (163).

4. The lock core structure as claimed in claim 1, wherein the hollow portion (111) has a filling hole (114) which is located diametrically corresponding to the side hole (113), the side bead unit (12) are inserted into the filling hole (114) which is sealed by an end cap (13).
